(19) United States
(12) Patent Application Publication
(10) Pub. No.: US 2021/0409302 A1
(43) Pub. Date: Dec. 30, 2021

(54) METHOD AND SYSTEM FOR CONSUMER PREMISES EQUIPMENT CONFIGURABLE SELF-HEAL

(71) Applicant: ARRIS Enterprises LLC, Suwanee, GA (US)

(72) Inventor: Michael R. KAHN, Cherry Hill, NJ (US)

(73) Assignee: ARRIS Enterprises LLC, Suwanee, GA (US)

(21) Appl. No.: 17/234,883

(22) Filed: Apr. 20, 2021

Related U.S. Application Data
(60) Provisional application No. 63/046,619, filed on Jun. 30, 2020.

(51) Int. Cl. H04L 12/26

(52) U.S. Cl. CPC H04L 43/10; H04L 43/0817; H04L 43/04; H04L 43/065

(57) ABSTRACT

A method and system are disclosed for consumer premises equipment configurable self-heal. The method includes identifying, by executing commands in application space, a signature in a log file, wherein the signature identifies a problem with the network connected device; identifying, by executing commands in application space, a signature script file associated with the signature, wherein the signature script file is stored after storing an initial software installation onto the network connected device; and executing at least one application space command of the signature script file to correct the problem with the network connected device.

### TECHNICAL FIELD

The present disclosure generally relates to a method and system for network connected devices that are configured to self-heal, and more particularly for identifying a signature that indicates a problem with the network connected device, and identifying a signature script file associated with the signature that includes at least one application space command that is executed on the network connected device to correct the problem with the network connected device.

### BACKGROUND

Cable service providers, which are also referred to as Multiple System Operators (“MSO”), or any communication or content distribution business that operates through a cable network, render their services to their subscribers. The services can include, but are not limited to, different subscription plans for broadband Internet access and telephony. In order to consume these services, subscribers connect to a private network owned (or co-owned or rented) by the broadband cable operator which is implemented according to the Data Over Cable Service Interface Specification (DOCSIS) standard.

Subscribers connect their computers, routers, voice-over-IP telephones and other devices to this network through network terminals, for example, cable modems (CM) or network gateways, which are also known as consumer-premise equipment or customer-provided equipment. The network terminals, for example, cable modems (CM) or network gateways include hardware which runs software that provides the low-level control for the device's specific hardware, which is known as firmware, which can be updated by pushing a new firmware version (or image) from time to time to the network gateway, for example, the cable modem (CM) or gateway. The firmware is installed on the network terminals as an initial software installation before the network terminals are deployed to the subscriber's location.

The network terminals, for example, the cable modems (CM) or gateways, generally include as part of their firmware an Operating System, which itself generally includes process and task management software systems. These process and task management systems coordinate the starting of various processes and tasks that are running on the network terminal as part of its operation, and include various methods of recovery if a process or a task encounters an error, some unexpected behavior of some other process or task, or otherwise enters into an error state. However, the methods of recovery of the process and task management systems are generally very coarse, such as restarting the process or task, or shutting down the process or task all together. Further, because the firmware of the network terminal is installed on the network terminal prior to deployment to the subscriber's location, any recovery methods can only be designed to recover for errors or operational problems that are known at the time of the firmware's design and installation, and not errors or operational problems that become known once the network terminal has been deployed. While the firmware of the network terminal can be updated, as described above, to include further recovery methods for errors or problems that become known once a network terminal is deployed, a less invasive, more flexible, less error prone, and less time consuming recovery updating process is needed to correct for errors or operational problems that become known once network terminals are deployed. This is particularly true because in many instances millions of network terminals may experience errors or operational problems that only become known after their deployment. The same is true for other network connected devices, such as Internet of Things devices, that include firmware and process and task management software systems that only include recovery methods for errors or operational problems that were known at the time of the firmware's design and installation onto the network connected device as an initial software installation.

### SUMMARY

In accordance with exemplary embodiments, it would be desirable to have a method and system for consumer premises equipment configurable self-heal, which addresses the need to update the recovery methods for consumer premises equipment, consumer-provided equipment, or other network connected devices after the initial software installation that is less invasive, more flexible, less error prone, and less time consuming than updating or pushing a new firmware version.

In accordance with an aspect, a method for self-healing of network connected devices is provided, the method comprising: identifying, by executing commands in application space, a signature in a log file, wherein the signature identifies a problem with the network connected device, identifying, by executing commands in application space, a signature script file associated with the signature, wherein the signature script file is stored after storing an initial software installation onto the network connected device, and executing at least one application space command of the signature script file to correct the problem with the network connected device.

In accordance with another aspect, a self-healing network connected device is provided, that includes a processor configured to: identify, by executing commands in application space, a signature in a log file, wherein the signature identifies a problem with the network connected device, identify, by executing commands in application space, a signature script file associated with the signature, wherein the signature script file is stored after storing an initial software installation onto the network connected device, and execute at least one application space command of the signature script file to correct the problem with the network connected device.

### BRIEF DESCRIPTION OF THE DRAWINGS

FIG. 1 is an illustration of an exemplary network environment for a method and system for consumer premises equipment configurable self-heal.

FIG. 2 is a flowchart illustrating an exemplary embodiment of consumer premises equipment configurable self-healing.

FIG. 3 is an illustration of a software and hardware architecture for a method and system for consumer premises equipment configurable self-heal.

FIG. 4 is an illustration of an embodiment of a signature file.

FIG. 5 is a flowchart illustrating an exemplary embodiment of consumer premises equipment configurable self-healing where a signature file and a signature script file are stored on a network connected device.

FIG. 6 is an illustration of an embodiment of network connected device configured to self-heal according to the present disclosure, where a signature file and a signature script file are stored on a writable portion of a storage device of the network connected device.

FIG. 7 is a further illustration of an embodiment of network connected device configured to self-heal according to the present disclosure, where a signature file and a signature script file are stored on a writable portion of a storage device of the network connected device.

FIG. 8 is a further illustration of an embodiment of network connected device configured to self-heal according to the present disclosure, where a signature file and a signature script file are stored on a writable portion of a storage device of the network connected device.

FIG. 9 is a further illustration of an embodiment of network connected device configured to self-heal according to the present disclosure, where a signature file and a signature script file are stored on a writable portion of a storage device of the network connected device.

FIG. 10 is a flowchart illustrating an exemplary embodiment of consumer premises equipment configurable self-healing where a signature file is stored on a network connected device and a signature script file is stored on a computing device of a Multiple System Operator.

FIG. 11 is a flowchart illustrating an exemplary embodiment of consumer premises equipment configurable self-healing where a signature file and a signature script file are stored on a computing device of a Multiple System Operator.

FIG. 12 is an exemplary hardware architecture for an embodiment of a network connected device.

### DETAILED DESCRIPTION

### System for Consumer Premises Equipment Configurable Self-Heal

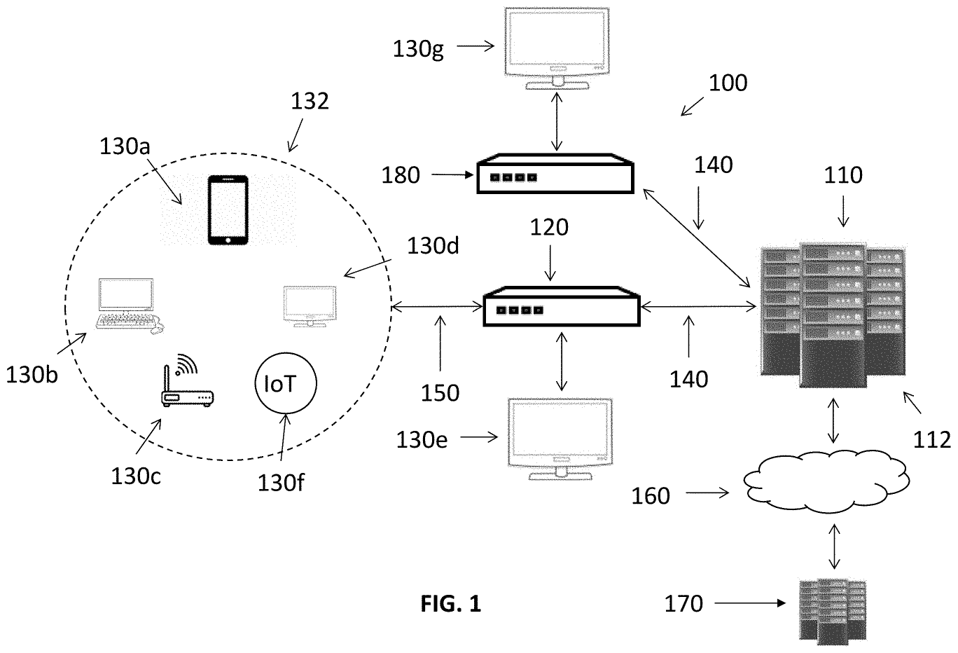

FIG. 1 is a block diagram illustrating an example network environment 100 operable for customer-premise equipment or customer-provided equipment (CPE) broadband devices 120. In accordance with an exemplary embodiment, the customer-premise equipment or customer-provided equipment (CPE) broadband device 120 can include, for example, a network gateway in the form of a modem/router/MTA device configured to provide voice, data, and video services. In embodiments, the CPE broadband device 120 can provide, for example, video and/or data services to a plurality of devices 130a, 130b, 130c, 130d, 130e, 130f. The CPE broadband device 120 may communicate with the plurality of devices 130a, 130b, 130c, 130d, 130f over a local network 132 (for example, a local area network (LAN), a wireless local area network (WLAN), a personal area network (PAN), etc.) through a connection 150, and may communicate with an upstream wide area network (WAN) 160 through a connection 140 to a cable provider 110. The CPE broadband device 120 may also be wired directly to a device, for example, a television 130e connected to an aspect of CPE broadband device 120 as a set top box (STB). As another example, an Internet of Things device 130f may also communicate with an upstream wide area network (WAN) 160 over a local network 132 through CPE broadband device 120 and through a connection 140 to a cable provider 110. In another embodiment, customer-premise equipment (CPE) 180 is a set top box (STB), and communicates with television 130g to provide video services. The connected devices 130a, 130b, 130c, 130d, 130e, 130f, 130g connected to the customer-premise equipment or customer-provided equipment (CPE) broadband device 120, or customer-premise equipment (CPE) 180 are embodiments of network connected devices. Customer-premise equipment or customer-provided equipment (CPE) broadband device 120, and customer-premise equipment (CPE) 180 are also embodiments of network connected devices.

The cable provider 110 can provide high-bandwidth data transfer, for example, cable television and broadband internet access via, for example, coaxial cables 140. The cable provider 110 can include one or more servers 112 configured to deliver services, for example, cable television and/or broadband internet and infrastructure supporting such services including management of image software and/or firmware. One or more servers 112 are embodiments of computing devices of a Multiple System Operator (MSO). Other servers 170 or resources 170 are accessible via wide area network (WAN) 160.

In accordance with an exemplary embodiment, the CPE broadband device 120 and the plurality of devices 130a, 130b, 130c, 130d, 130e, 130f can be configured to connect via a wireless network, for example, wireless network utilizing an IEEE 802.11 specification, including a set-top box (STB), a smart phone, a smart TV, a computer, a mobile device, a tablet, a router, a home security system, an Internet of Things device, or any other device operable to communicate wirelessly with the CPE broadband device 120. The CPE broadband device 120 may provide access to an external network, such as the Internet, for any devices connected thereto via the area network 132. The area network 132 may be, for instance a local area. In accordance with an exemplary embodiment, the CPE broadband device 120 may be a gateway device, an access point, a modem, a wireless router including an embedded modem, a wireless network extender or any other device operable to deliver, for example, data and/or video services from the provider 110 and/or a wide area network (WAN) 160 to one or more of the plurality of devices 130a, 130b, 130c, 130d, 130e, 130f.

In accordance with an exemplary embodiment, the CPE broadband device 120 may communicate with the provider 110 over a wired or a wireless connection. A wireless connection between the provider 110 and the CPE broadband device 120 may be established through a protected setup sequence (for example, Wi-Fi protected setup (WPS)). The protected setup sequence may include the steps of scanning multiple wireless channels for an available access point, exchanging one or more messages between a station and access point, exchanging key messages (for example, pre-shared key (PSK)) between the station and access point, and installing a key (for example, PSK) at the station.

### Process for Consumer Premises Equipment Configurable Self-Heal

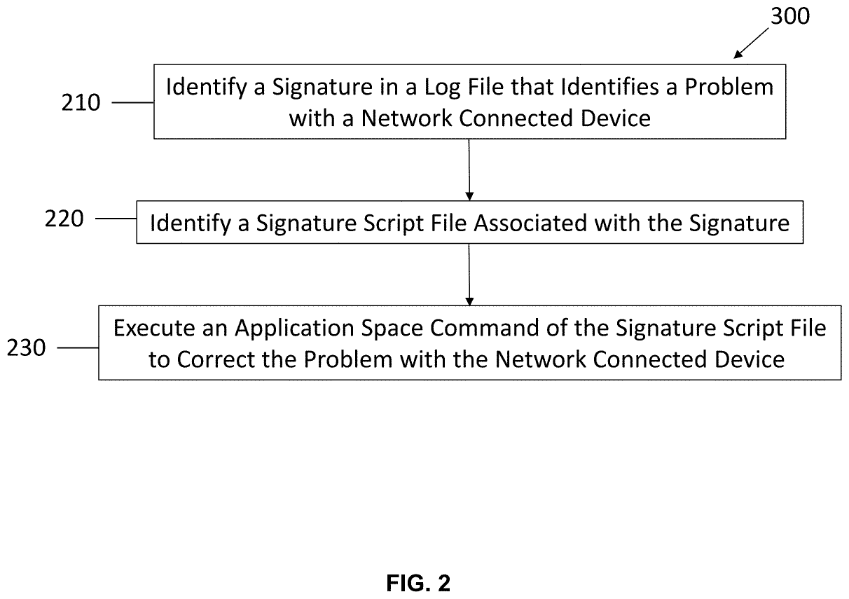

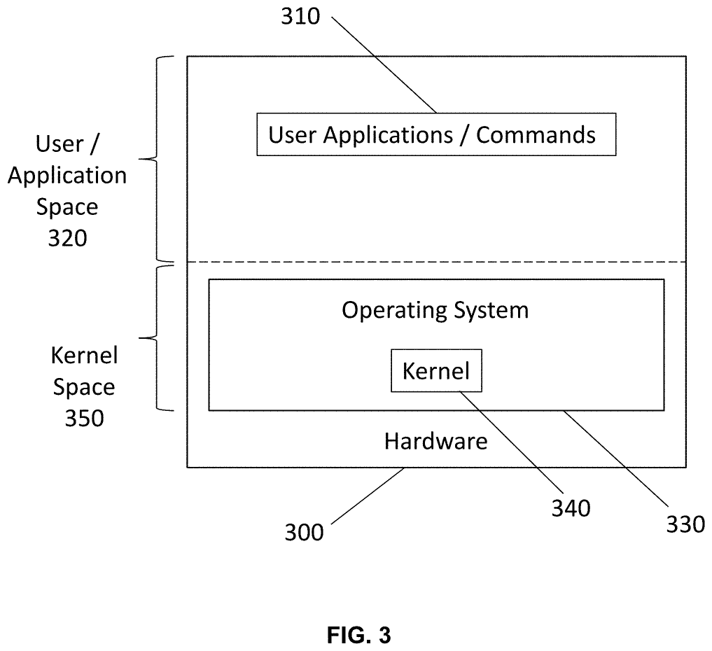

FIG. 2 is a flowchart illustrating an exemplary embodiment of consumer premises equipment configurable self-healing. As shown in FIG. 2, the process starts in step 210. In step 210, a signature in a log file is identified. The signature in the log file is identified by executing commands in application space. In this regard, reference is made to FIG. 3. FIG. 3 is an illustration of a software and hardware architecture for a method and system for consumer premises equipment configurable self-heal. As shown in FIG. 3, an Operating System 330 with a Kernel 340 executes as software on hardware 300. That portion of the software operates in kernel space 350. As also illustrated in FIG. 3, user applications and commands 310 operate outside the core of the Operating System, and interface with the core of the Operating System. That portion of the software operates in user or application space 320, and the commands executing in that space are user or application space commands.

Turning back to FIG. 2., the signature in the log file identifies a problem with the network connected device. Examples of problems with the network connected device include an unstable network condition, the remaining storage of the network connected device has fallen below an acceptable limit, a process or a task has experienced an unexpected behavior from another process or task, or any other error state of the network connected device. Following step 210, in step 220 a signature script file is identified that is associated with the signature. As with step 210, step 220 is performed by executing commands in application space. The signature script file is stored after storing an initial software installation onto the network connected device. This accounts for errors or operational problems that only become known after the network connected device's deployment, for example, to a subscriber's location. Following step 220, in step 230 at least one application space command is executed to correct the problem with the network connected device.

The process of FIG. 2 is scalable to any number of signatures and any number of signature files to address any number of problems with the network connected device. In this way, numerous errors or operational problems that only become known after the network connected device's deployment can be addressed using is a less invasive, more flexible, less error prone, and less time consuming solution compared to updating or pushing a new firmware version. Additionally, the present disclosure may be implemented across large numbers of network connected devices, in many cases numbering in the millions, that share the same hardware and software configuration.

In some embodiments, the process illustrated in FIG. 2 is performed by periodically evaluating the log file, so that step 210 of identifying the signature in the log file is the result of evaluating the log file periodically. As an example, the log file may be periodically evaluated every 5 minutes. In some embodiments, a signature process that evaluates the log file may be included as part of the network connected device's firmware, and configured to execute every 5 minutes. In such an embodiment, the signature process may be configured to check for the existence of signature files, and perform evaluation of a log file identified in an individual signature file. In some embodiments, a signature process is scheduled using the Operating System's existing scheduling mechanism, such as the cron job scheduler of Unix-like operating systems such as Linux, macOS, and FreeBSD.

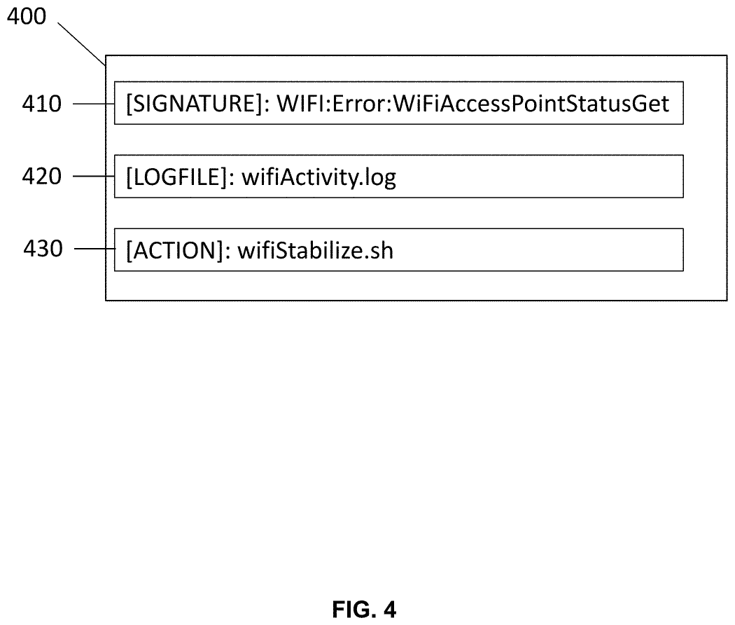

In some embodiments a signature is stored in a signature file. FIG. 4 is an illustration of an embodiment of a signature file 400. As illustrated in FIG. 4, the signature file 400 includes a signature field 410 that identifies a signature. In the exemplar embodiment, the signature is a text string “WIFI:Error:WiFiAccessPointStatusGet” and identifies an unstable wireless network condition as the problem with the network connected device. The signature file 400 also includes a log file field 420 that identifies a log file. In the exemplar embodiment, the log file is “wifiActivity.log.” In some embodiments, the log file field 420 also includes a path of the file system of the network connected device where the log file can be found. In the embodiment of FIG. 4, signature file 400 also includes an action field 430 that identifies a signature script file associated with the signature. In the example shown, the signature script file is “wifiStabilize.sh.”

In one embodiment, signature script file “wifiStabilize.sh” is a bash script that includes application space commands that are directly executable at the command line interface of the network connected device, but are instead executed using the script “wifiStabilize.sh.” For example, “wifiStabilize.sh” could include the following commands:

rm /tmp/wifi.channel

wifi_radio_rescan

In the above example, the application space commands include removing a file “wifi.channel” from the path “/tmp” on the network connected device by the command “rm /tmp/wifi.channel,” and rescanning for new channel information by the command “wifi_radio_rescan,” which will correct the unstable network problem that was identified by signature field 410 in the FIG. 4. embodiment. In other embodiments, the signature script file is python script, a perl script, or a script in any other scripting language supported by the network connected device, that can execute application space commands including those directly executable on the network connected device's command line interface. In some embodiments, only a single application space command needs to be executed to correct the problem with the network connected device. In such embodiments, the signature script file includes only the single application space command. In other embodiments, the signature script file contains numerous commands, including commands to download files necessary to perform the correction to the network connected device.

Considering also FIG. 2, in embodiments that include a signature file, such as the one shown in FIG. 4, method step 210 of identifying the signature in the log file includes reading the signature file to obtain the signature information and the log file information, and method step 220 of identifying the signature script file associated with the signature includes reading the signature file to obtain the signature script file information.

In other embodiments that include a signature file, the process illustrated in FIG. 2 may include an additional step of downloading a downloadable file to the network connected device before the step 230 of executing any commands from the signature script file. In such an embodiment, the signature script file, such as that of the embodiment of FIG. 4, includes as part of its action field 430 an identification of the downloadable file. In some embodiments, the identification of the downloadable file includes a network location of the downloadable file, such as a Universe Resource Locator (URL) of the file. In some embodiments, the identification of the downloadable file includes credentials associated with the URL of the downloadable file. As an example, the identification of the downloadable file could include an internet FTP address along with credentials to login and download the downloadable file. In some embodiments, the downloadable file could be a software patch for portions of the firmware of the network connected device, and at least one command of the signature script file identified in the action field 430 of the corresponding signature file 400 is an application space command to apply the software patch. In other embodiments, numerous downloadable files are identified in the action field 430 of a corresponding signature file 400.

Considering also FIG. 2, in embodiments that include a downloadable file identified by the action field 430 of a corresponding signature file 400, method step 230 of executing an application space command may cause the network connected device to read and use at least some of the contents of the downloadable file. Similarly, in embodiments with numerous downloadable files identified in the action field 430 of a corresponding signature file 400, method step 230 of executing an application space command may cause the network connected device to read and use at least some of the contents of the downloadable files.

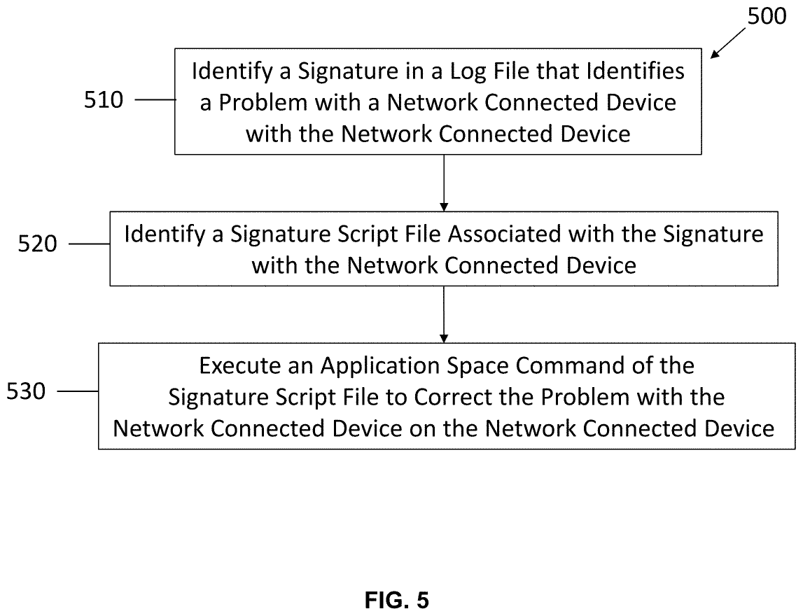

FIG. 5 is a flowchart 500 illustrating an exemplary embodiment of consumer premises equipment configurable self-healing where a signature file and a signature script file are stored on a network connected device. In the embodiment of FIG. 5, the signature file and the signature storage file are stored on a writable portion of a storage device of the network connected device. As illustrated in step 510, in such an embodiment, identifying the signature in the log file is performed by the network connected device itself. Similarly, as illustrated in step 520, identifying the signature script file associated with the signature is also performed by the network connected device itself. Lastly, to fix the problem, in step 530, the network connected device executes at least one application space command of the signature script file to correct the problem with the network connected device. In some embodiments, the signature file is authenticated before being used. For example, the signature file may be digitally signed and authenticated by the network connected device prior to its use. In embodiments, the signature script file is authenticated prior to its use. For example, the signature script file may be digitally signed and authenticated by the network connected device prior to its use.

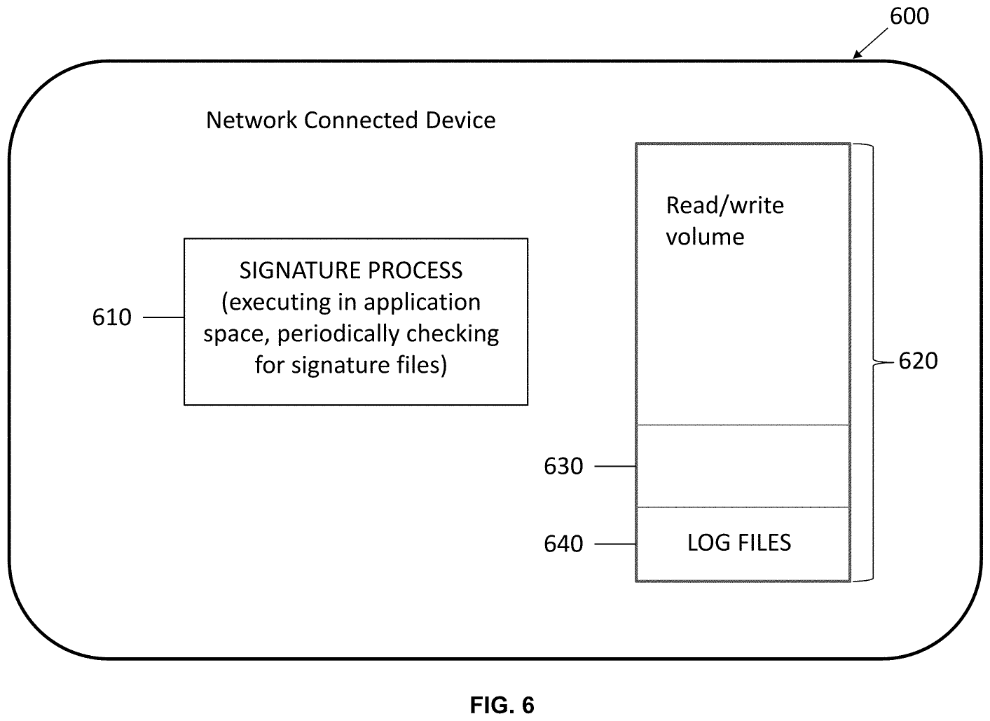

FIG. 6 is an illustration of an embodiment of network connected device 600 configured to self-heal according to the present disclosure, where a signature file and a signature script file are stored on a writable portion of a storage device of the network connected device. In the embodiment of FIG. 6, a signature process 610 is included as part of the network connected device's firmware, as previously described. The signature process 610 is scheduled to execute periodically, and checks for the existence of signature files in the writable portion 630 of the network connected device's storage 620. As illustrated in FIG. 6, there are currently no signature files stored in writable portion 630. Also illustrated in FIG. 6 is a portion of the storage 620 that includes log files 640, that may be evaluated by the signature process if a signature file is stored in the writable portion 630.

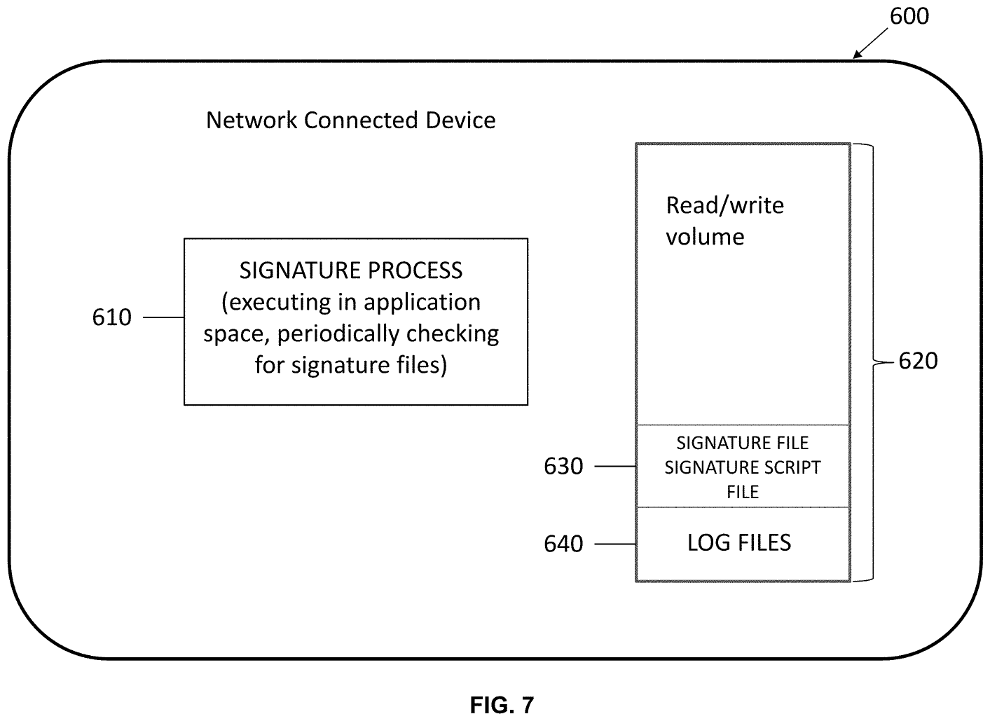

FIG. 7 is a further illustration of an embodiment of the network connected device 600 configured to self-heal according to the present disclosure, where a signature file and a signature script file are stored on a writable portion of a storage device of the network connected device. In FIG. 7, a signature file and a signature script file have been loaded on the writable portion 630 of the network connected device's storage 620. In some embodiments, this is the result of the Multiple System Operator identifying a new problem that may occur with the network connected device, and pushing or uploading the signature file and the signature script file to the network connected device. In such an embodiment, a notification may be sent to a user associated with the network connected device notifying the user that the signature file and the signature script file have been pushed or uploaded to the network connected device as a solution for a problem with the network connected device. In such an embodiment, the process shown in FIG. 5 may further include the steps of storing the signature file on the writable portion of the storage device of the network connected device as transmitted from a computing device of a Multiple Systems Operator (for example, a Server 112 of FIG. 1), and storing the signature script file on the writable portion of the storage device of the network connected device as transmitted from the computing device of the Multiple Systems Operator (for example, a Server 112 of FIG. 1).

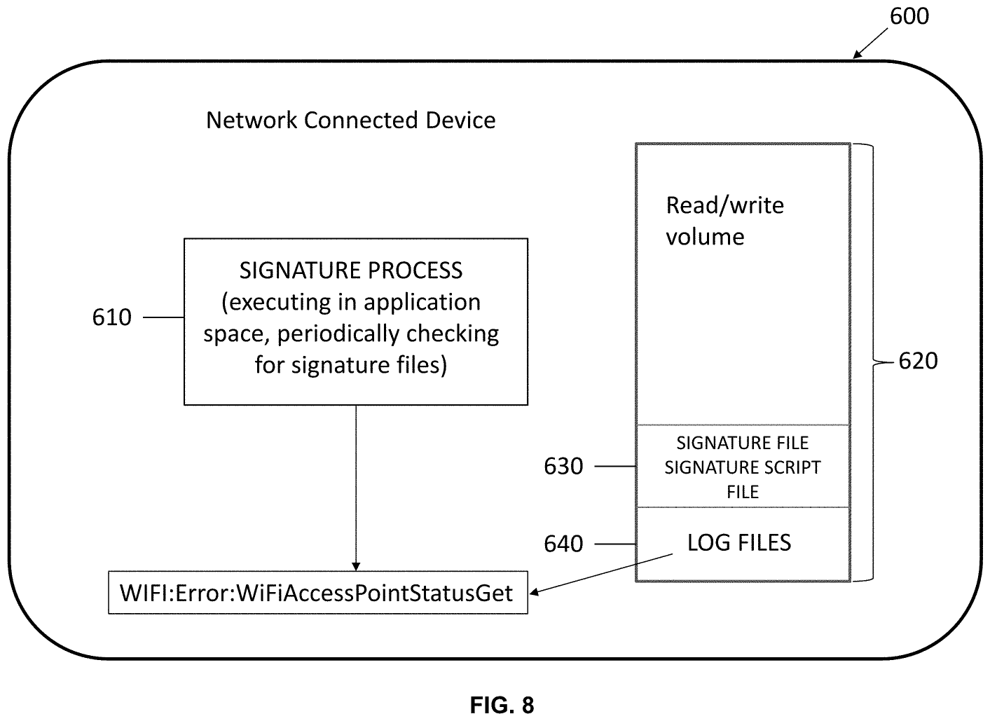

FIG. 8 is a further illustration of an embodiment of network connected device 600 configured to self-heal according to the present disclosure, where a signature file and a signature script file are stored on a writable portion of a storage device of the network connected device. FIG. 8 illustrates the signature process 610 identifying the existence of the signature file stored in the writable portion 630, and identifying a signature in a log file identified by that signature file. In the embodiment of FIG. 8, the exemplary signature is “WIFI:Error:WiFiAccessPointStatusGet”, as previously discussed above as identifying an unstable wireless network condition as the problem with the network connected device.

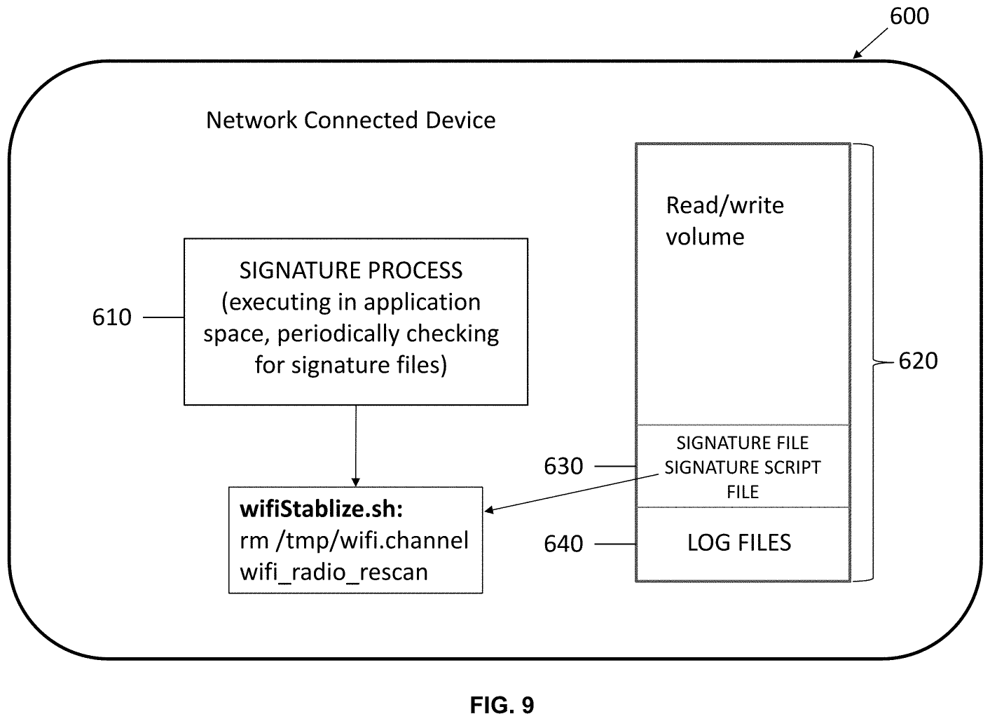

FIG. 9 is a further illustration of an embodiment of network connected device 600 configured to self-heal according to the present disclosure, where a signature file and a signature script file are stored on a writable portion of a storage device of the network connected device. FIG. 9 illustrates the signature process identifying a signature script file associated with the signature file as stored in the writable portion 630 of the network device's storage 620. FIG. 9 also illustrates the execution of application space commands of the signature script file to correct the problem of the network connected device, in the form of the “wifiStablize.sh” signature script file, as previously discussed above with the application space commands:

rm /tmp/wifi.channel

wifi_radio_rescan

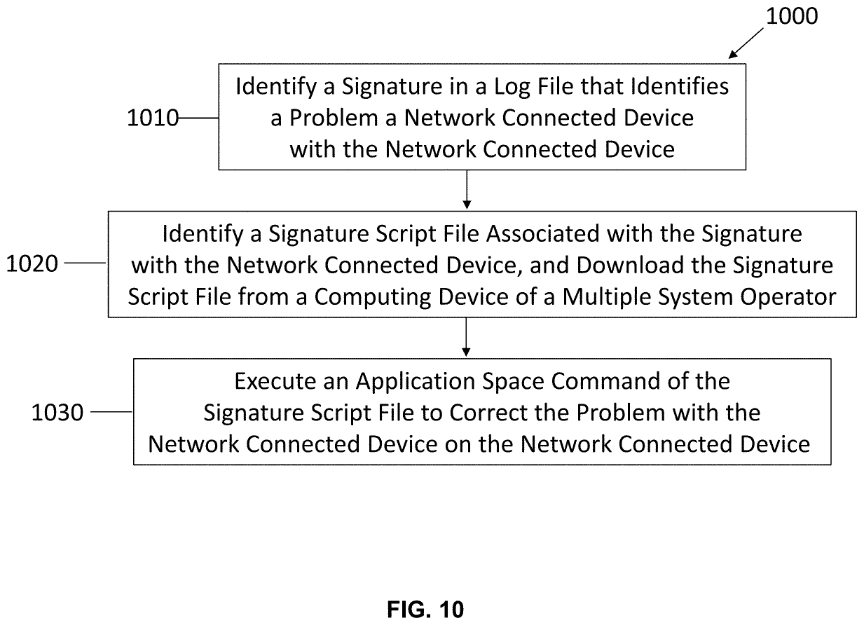

FIG. 10 is a flowchart 1000 illustrating an exemplary embodiment of consumer premises equipment configurable self-healing method where a signature file is stored on a network connected device and a signature script file is stored on a computing device of a Multiple System Operator. In the embodiment of FIG. 10, the signature file is stored on a writable portion of a storage device of the network connected device. As illustrated in step 1010, in such an embodiment, identifying the signature in the log file is performed by the network connected device itself. Thereafter, in step 1020 the network connected device identifies a signature script file associated with the signature, and downloads the signature script file from a computing device of a Multiple System Operator (for example, Server 112 of FIG. 1). Lastly, to fix the problem, in step 1030, the network connected device executes at least one application space command of the signature script file to correct the problem with the network connected device.

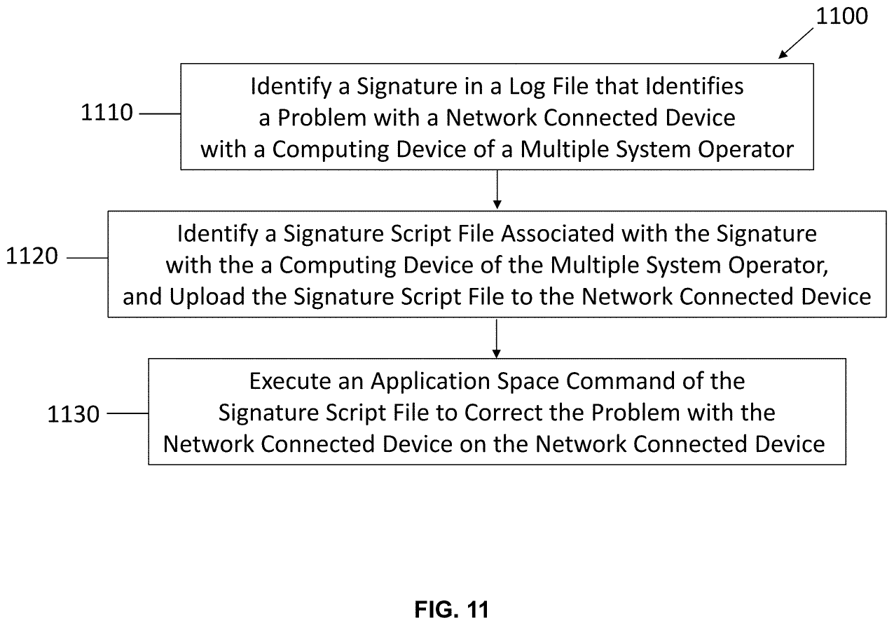

FIG. 11 is a flowchart 1100 illustrating an exemplary embodiment of consumer premises equipment configurable self-healing where a signature file and a signature script file are stored on a computing device of a Multiple System Operator. In the embodiment of FIG. 11, the process starts with step 1110 where a computing device of a Multiple System Operator (for example, Server 112 of FIG. 1) identifies a signature in a log file. In such an embodiment, the log file may be periodically downloaded from the network connected device to the computing device of the Multiple System Operator, or uploaded from the network connected device to the computing device of the Multiple System Operator. In step 1120, the computing device of the Multiple System Operator identifies a signature script file associated with the signature, and uploads the signature script file from the computing device of the Multiple System Operator to the network connected device. Lastly, in step 1130, the network connected device executes at least one application space command of the signature script file to correct the problem with the network connected device.

### Computer System Architecture

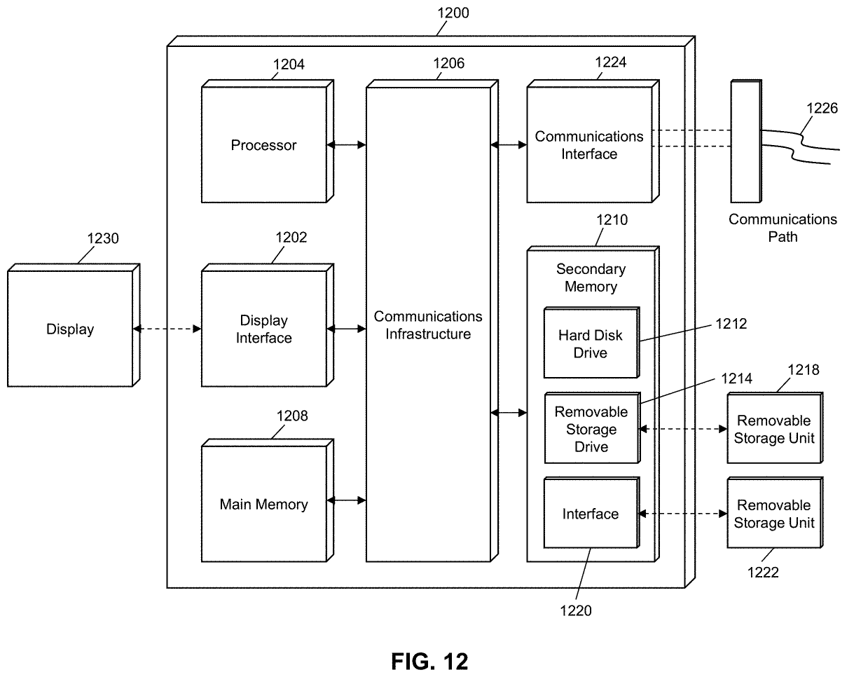

FIG. 12 illustrates a representative computer system 1200 in which embodiments of the present disclosure, or portions thereof, may be implemented as computer-readable code executed on a processor of a computer. For example, the one or more servers 112, the CPE broadband device 120, CPE device 180, and the plurality of devices 130a, 130b, 130c, 130d, 130e, 130f, 130g of FIG. 1 may be implemented in whole or in part by a computer system 1200 using hardware, software executed on hardware, firmware, non-transitory computer readable media having instructions stored thereon, or a combination thereof and may be implemented in one or more computer systems or other processing systems. Hardware, software executed on hardware, or any combination thereof may embody modules and components used to implement the methods and steps of the present disclosure.

If programmable logic is used, such logic may execute on a commercially available processing platform configured by executable software code to become a specific purpose computer or a special purpose device (for example, programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 1218, a removable storage unit 1222, and a hard disk installed in hard disk drive 1212.

Various embodiments of the present disclosure are described in terms of this representative computer system 1200. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 1204 may be a special purpose or a general purpose processor device specifically configured to perform the functions discussed herein. The processor device 1204 may be connected to a communications infrastructure 1206, such as a bus, message queue, network, multi-core message-passing scheme, etc. The network may be any network suitable for performing the functions as disclosed herein and may include a local area network (“LAN”), a wide area network (“WAN”), a wireless network (e.g., “Wi-Fi”), a mobile communication network, a satellite network, the Internet, fiber optic, coaxial cable, infrared, radio frequency (“RF”), or any combination thereof. Other suitable network types and configurations will be apparent to persons having skill in the relevant art. The computer system 1200 may also include a main memory 1208 (e.g., random access memory, read-only memory, etc.), and may also include a secondary memory 1210. The secondary memory 1210 may include the hard disk drive 1212 and a removable storage drive 1214, such as a floppy disk drive, a magnetic tape drive, an optical disk drive, a flash memory, etc.

The removable storage drive 1214 may read from and/or write to the removable storage unit 1218 in a well-known manner. The removable storage unit 1218 may include a removable storage media that may be read by and written to by the removable storage drive 1214. For example, if the removable storage drive 1214 is a floppy disk drive or universal serial bus port, the removable storage unit 1218 may be a floppy disk or portable flash drive, respectively. In one embodiment, the removable storage unit 1218 may be non-transitory computer readable recording media.

In some embodiments, the secondary memory 1210 may include alternative means for allowing computer programs or other instructions to be loaded into the computer system 1200, for example, the removable storage unit 1222 and an interface 1220. Examples of such means may include a program cartridge and cartridge interface (e.g., as found in video game systems), a removable memory chip (e.g., EEPROM, PROM, etc.) and associated socket, and other removable storage units 1222 and interfaces 1220 as will be apparent to persons having skill in the relevant art.

Data stored in the computer system 1200 (e.g., in the main memory 1208 and/or the secondary memory 1210) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 1200 may also include a communications interface 1224. The communications interface 1224 may be configured to allow software and data to be transferred between the computer system 1200 and external devices. Exemplary communications interfaces 1224 may include a modem, a network interface (e.g., an Ethernet card), a communications port, a PCMCIA slot and card, etc. Software and data transferred via the communications interface 1224 may be in the form of signals, which may be electronic, electromagnetic, optical, or other signals as will be apparent to persons having skill in the relevant art. The signals may travel via a communications path 1226, which may be configured to carry the signals and may be implemented using wire, cable, fiber optics, a phone line, a cellular phone link, a radio frequency link, etc.

The computer system 1200 may further include a display interface 1202. The display interface 1202 may be configured to allow data to be transferred between the computer system 1200 and external display 1230. Exemplary display interfaces 1202 may include high-definition multimedia interface (HDMI), digital visual interface (DVI), video graphics array (VGA), etc. The display 1230 may be any suitable type of display for displaying data transmitted via the display interface 1202 of the computer system 1200, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 1208 and secondary memory 1210, which may be memory semiconductors (e.g., DRAMs, etc.). These computer program products may be means for providing software to the computer system 1200. Computer programs (e.g., computer control logic) may be stored in the main memory 1208 and/or the secondary memory 1210. Computer programs may also be received via the communications interface 1224. Such computer programs, when executed, may enable computer system 1200 to implement the present methods as discussed herein. In particular, the computer programs, when executed, may enable processor device 1204 to implement the methods illustrated by FIGS. 1-11, as discussed herein. Accordingly, such computer programs may represent controllers of the computer system 1200. Where the present disclosure is implemented using software executed on hardware, the software may be stored in a computer program product and loaded into the computer system 1200 using the removable storage drive 1214, interface 1220, and hard disk drive 1212, or communications interface 1224.

The processor device 1204 may comprise one or more modules or engines configured to perform the functions of the computer system 1200. Each of the modules or engines may be implemented using hardware and, in some instances, may also utilize software executed on hardware, such as corresponding to program code and/or programs stored in the main memory 1208 or secondary memory 1210. In such instances, program code may be compiled by the processor device 1204 (e.g., by a compiling module or engine) prior to execution by the hardware of the computer system 1200. For example, the program code may be source code written in a programming language that is translated into a lower level language, such as assembly language or machine code, for execution by the processor device 1204 and/or any additional hardware components of the computer system 1200. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 1200 to perform the functions disclosed herein. It will be apparent to persons having skill in the relevant art that such processes result in the computer system 1200 being a specially configured computer system 1200 uniquely programmed to perform the functions discussed above.

Techniques consistent with the present disclosure provide, among other features, systems and methods for consumer premises equipment configurable self-heal, which addresses the need to update the recovery methods for consumer premises equipment, consumer-provided equipment, or other network connected devices after the initial software installation that is less invasive, more flexible, less error prone, and less time consuming than updating or pushing a new firmware version. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for self-healing a network connected device, the method comprising:
identifying, by executing commands in application space, a signature in a log file, wherein the signature identifies a problem with the network connected device;
identifying, by executing commands in application space, a signature script file associated with the signature, wherein the signature script file is stored after storing an initial software installation onto the network connected device; and
executing at least one application space command of the signature script file to correct the problem with the network connected device.

2. The method of claim 1, wherein the signature is stored in a signature file, stored after storing an initial software installation onto the network connected device, that comprises a signature field identifying the signature, a log file field identifying the log file, and an action field identifying the signature script file associated with the signature.

3. The method of claim 2, wherein identifying the signature in the log file includes reading the signature file to obtain signature information and log file information, and
wherein identifying the signature script file associated with the signature includes reading the signature file to obtain the signature script file information.

4. The method of claim 1, wherein the at least one application space command is executable directly at a command line interface of the network connected device, and
wherein executing the at least one application space command is performed by the network connected device.

5. The method of claim 2, further comprising:
downloading a downloadable file to the network connected device before executing the at least one application space command, wherein the action field of the signature file identifies the downloadable file, and the at least one application space command causes the network connected device to read and use at least some of the contents of the downloadable file.

6. The method of claim 1, further comprising:
evaluating the log file periodically, and identifying the signature in the log file as a result of evaluating the log file periodically.

7. The method of claim 1, wherein the network connected device is a set-top box, a modem, a router, or an Internet of Things device.

8. The method of claim 2, wherein the signature file is stored on a writable portion of a storage device of the network connected device,
wherein the signature script file is stored on a writable portion of a storage device of the network connected device,
wherein identifying the signature in the log file is performed by the network connected device,
wherein identifying the signature script file associated with the signature is performed by the network connected device, and
wherein executing the at least one application space command of the signature script file to correct the problem with the network connected device is performed by the network connected device.

9. The method of claim 8, further comprising:
storing the signature file on the writable portion of the storage device of the network connected device as transmitted from a computing device of a Multiple Systems Operator; and
storing the signature script file on the writable portion of the storage device of the network connected device as transmitted from the computing device of the Multiple Systems Operator.

10. The method of claim 2, wherein the signature file is stored on a writable portion of a storage device of the network connected device,
wherein identifying the signature in the log file is performed by the network connected device,
wherein identifying the signature script file associated with the signature is performed by the network connected device, and includes downloading the signature script file from a computing device of a Multiple System Operator, and
wherein the step of executing the at least one application space command of the signature script file to correct the problem with the network connected device is performed by the network connected device.

11. The method of claim 1,
wherein identifying the signature in the log file is performed by a computing device of a Multiple System Operator,
wherein identifying the signature script file associated with the signature is performed by the computing device of the Multiple System Operator, and includes uploading the signature script file from the computing device of the Multiple System Operator to the network connected device, and
wherein executing the at least one application space command of the signature script file to correct the problem with the network connected device is performed by the network connected device.

12. A self-healing network connected device, comprising:
a processor configured to:
identify, by executing commands in application space, a signature in a log file, wherein the signature identifies a problem with the network connected device;
identify, by executing commands in application space, a signature script file associated with the signature, wherein the signature script file is stored after storing an initial software installation onto the network connected device; and
execute at least one application space command of the signature script file to correct the problem with the network connected device.

13. The self-healing network connected device of claim 12, wherein the signature is stored in a signature file, stored after storing an initial software installation onto the network connected device, that comprises a signature field identifying the signature, a log file field identifying the log file, and an action field identifying the signature script file associated with the signature.

14. The self-healing network connected device of claim 13, wherein the processor is configured to:
read the signature file to obtain signature file information and log file information before identifying the signature in the log file; and
read the signature file to obtain the signature script file information before identifying the signature script file associated with the signature.

15. The self-healing network connected device of claim 12, wherein the at least one application space command is executable directly at a command line interface of the network connected device.

16. The self-healing network connected device of claim 13, wherein the processor is configured to:
download a downloadable file to the network connected device before executing the at least one application space command, wherein the action field of the signature file identifies the downloadable file, and the at least one application space command causes the network connected device to read and use at least some of the contents of the downloadable file.

17. The self-healing network connected device of claim 12, wherein the processor is configured to:
evaluate the log file periodically, and identify the signature in the log file as a result of evaluating the log file periodically.

18. The self-healing network connected device of claim 12, wherein the network connected device is a set-top box, a modem, a router, or an Internet of Things device.

19. The self-healing network connected device of claim 13, wherein the signature file is stored on a writable portion of a storage device of the network connected device, and wherein the signature script file is stored on a writable portion of a storage device of the network connected device.

20. The self-healing network connected device of claim 13, wherein the processor is configured to:
store the signature file on the writable portion of the storage device of the network connected device as transmitted from a computing device of a Multiple Systems Operator; and
store the signature script file on the writable portion of the storage device of the network connected device as transmitted from the computing device of the Multiple Systems Operator.

21. The self-healing network connected device of claim 13, wherein the signature file is stored on a writable portion of a storage device of the network connected device, and wherein the processor is configured to:
download the signature script file associated with the signature from a computing device of a Multiple System Operator based on the signature script file information read from the signature file.

22. A non-transitory computer readable medium having instructions operable to cause one or more processors to perform the operations comprising:
identify, by executing commands in application space, a signature in a log file, wherein the signature identifies a problem with the network connected device;
identify, by executing commands in application space, a signature script file associated with the signature, wherein the signature script file is stored after storing an initial software installation onto the network connected device; and
execute at least one application space command of the signature script file to correct the problem with the network connected device.
